(19) United States
(12) Patent Application Publication
(10) Pub. No.: US 2002/0121779 A1
(43) Pub. Date: Sep. 5, 2002

(54) Bell and spigot joint for steel pipe

(76) Inventors: William T. Adams JR., Hoover, AL (US); Gene L. Oliver, Hoover, AL (US)

Correspondence Address: John C. Kerins, MILES & STOCKBRIDGE P.C., Suite 500, 1751 Pinnacle Drive, McLean, VA, 22102, US

(21) Appl. No.: 09/795,107

(22) Filed: Mar. 1, 2001

(51) Int. Cl. F16L 17/00

(52) U.S. Cl. 285/374

(57) ABSTRACT

A steel pipe element and a pipe joint for steel pipe are provided, in which the steel pipe element has a bell end including a necked-down terminal end, an annular recess portion extending axially inwardly of the necked-down portion, and being of greater interior diameter than a main cylindrical section of the pipe. A gasket retaining ring is secured in the bell end at a position extending circumferentially around the annular recess portion, and retains thereon a resilient gasket held in slight compression by the bell end of the pipe element. In the pipe joint, a spigot end of a second pipe element is inserted, in a “push-on” manner, into the bell end, whereupon the spigot end is engaged by the gasket, which itself is further compressed between the bell end and the spigot end, thereby providing a fluid-tight seal and an ability to allow for joint deflection at the joint.

### BACKGROUND OF THE INVENTION

1. Field of the Invention

The present invention relates to bell-and-spigot pipe joint designs, and more specifically to such pipe joint designs as are used with steel pipe.

2. Description of Related Art

Steel pipe is frequently used for water service. A significant distinction between steel pipe and ductile cast iron pipe, from a manufacturing perspective, is that ductile cast iron pipe is generally produced in a centrifugal casting mold, with the mold walls shaped to provide the desired outer pipe configuration. The pipewall thickness over most of the length of the pipe is obtained simply by controlling the quantity of molten iron introduced into the mold in a casting cycle. In the production of ductile cast iron pipe of the bell-and-spigot type, one end of the mold is flared to create the enlarged or bell end of the pipe. The desired shape or configuration of the interior of the pipe at the bell end, (or elsewhere, if desired) can be obtained by using a core element about which the molten iron solidifies to produce the desired shaping. As a result of the manufacturing process for ductile cast iron pipe, it has been known in that art to produce a bell end having an interior configuration having projections and/or recesses suitable for retaining a gasket member in place. The gasket is placed in its desired position within the bell end prior to the spigot end of an adjoining section of pipe being inserted therein. Examples of this type of joint designed for centrifugally cast ductile iron pipe can be seen in U.S. Pat. No. 5,067,751 and U.S. Pat. No. 5,197,768.

Steel pipe is not made by a centrifugal casting process, and is generally produced from flat steel plate or skelp by plastically deforming the plate into a hollow, substantially cylindrical shape, and then joining the two adjacent or abutting edges of the steel plate by welding. One common type of such steel pipe is referred to a spiral-welded pipe, in that the edges of the steel plate to be joined extend along the length of the pipe in a spiral or helical pattern, thus giving rise to a spiral weld bead once the edges are joined.

Sections of steel pipe are frequently welded to adjacent sections in forming a pipeline, although there are certain applications in which push-on, gasketed joints have been seen as being advantageous. However, unlike the situation with ductile cast iron pipe, in which the exterior and the interior of a bell end can be readily produced in a desired shape, the ability to shape the bell end, and, in particular, the interior of a bell end, of a steel pipe is considerably more limited.

Gasketed joint configurations have been designed and used in the past for bell-and-spigot steel pipe sections, and five examples of such joint configurations are presented in FIGS. 1A-1E herein. These joint designs are also illustrated in the American Water Works Association (AWWA) Manual M11—“Steel Pipe—A Guide for Design and Installation”, as exemplifying the types of rubber-gasketed field push-on pipe joint configurations that have been developed. The Manual notes that this type of joint has the benefits of allowing flexibility and deformation in the line, ease of assembly, and that it is an economical design. The Manual further notes that this type of joint presents potential problems with maintaining joint integrity, and that caution should be exercised in the manufacture of the pipe to maintain tight clearance between bells and spigots.

The pipe joints illustrated in FIGS. 1A-1E have been seen to suffer from problems with joint integrity even beyond those experienced due to out-of-tolerance manufacturing. In the joint designs illustrated in FIGS. 1A-1E, the gasket is carried by the spigot end of the pipe for insertion into a bell end of an adjoining pipe. Even though the spigot end in each of these designs has physical obstructions which are provided in order to attempt to prevent movement of the gasket away from its desired position, the common practice in the industry is to use a rubber gasket of a size such that the gasket is in 30% extension (diameter 30% greater than initial diameter) when in position on the spigot end of the pipe, in order to prevent the gasket from rolling out of the desired position within the retention means. This use of a highly deformed gasket reduces the ability of the gasket to closely and tightly engage the inner wall of the bell end of the adjoining pipe. Further, the amount of permissible deflection of the joint is reduced, in that the elongation reduces the amount of elastic deformation remaining in the gasket, and thus impairs its ability to form a tight, uniform, seal in the joint.

It has commonly been agreed or accepted in the steel pipe art that, because of the drawbacks or limitations associated with the push-on joint designs previously developed using a rubber gasket seal, the maximum pipe diameter with which rubber gasketed joints can be used effectively is 72 inches (72″, 182.9cm).

It can be seen from the pipe joint designs of FIGS. 1A-1E that the ability to form the bell end 12 of the pipe 10 of a steel pipe section is generally limited to providing an expanded diameter section 14 which is to engage the gasket 16 retained on spigot 18 inserted therein. A flared end section 20 is provided at the extreme outer portion of the bell end 12. Indeed, in FIG. 1C, the bell end 12 is formed separately from the pipe section, and is welded thereto, at welds 22, in recognition of the difficulty in producing a bell end at the end of a steel pipe section. In FIG. 1E, the spigot 18 is roll deformed to create a gasket retaining recess 24, by expanding portions of the diameter of the spigot end, at spaced apart locations, thus forming recess 24 at a location near the end of the spigot end 16. Notwithstanding the less-than optimal performance of these joint configurations, no attempt has been made in the art of push-on steel pipe joints to design the bell end of the pipe such that it is capable of retaining a gasket therein, through which an adjoining spigot end may be inserted.

It is therefore a principal object of the present invention to provide a push-on pipe joint design for steel pipe which has improved properties, including a high integrity seal and an increased range of allowable joint deflection.

It is a further important object of the present invention to provide a push-on pipe joint design for steel pipe which includes a gasket-retaining element disposed in the bell end of the pipe.

It is an additional important object of the present invention to provide a push-on pipe joint design for steel pipe that provides the above-discussed advantages in a relatively economical design.

### SUMMARY OF THE INVENTION

The above and other objects of the present invention are obtained by providing a bell end configuration for welded steel pipe sections, the interior of which has, at an appropriate distance from the outer edge of the bell end of a steel pipe section, a retaining ring secured therein. The retaining ring extends either continuously or intermittently around the inner surface of the bell end. The retaining ring is shaped and sized so as to provide an effective gasket-retaining function. The outer extent of the bell end is also formed to have an inward taper at its outer end, which aids in properly positioning and seating the gasket.

In making up the joint, a resilient gasket member of a diameter slightly in excess of the inner diameter of the bell end is inserted into the bell end and is positioned such that the gasket retaining ring engages the outer surface of the gasket. The gasket is sized such that, as it takes on its annular shape, it is retained in slight compression by the inner wall of the bell end of the pipe. The pipe joint is completed by inserting a plain spigot end of another section of steel pipe into the bell end, and axially past the gasket.

The retaining ring keeps the gasket in position during this insertion of the spigot end during joint makeup. The design of the retaining ring is also such that it aids in retaining the gasket in its proper position when the joint is under pressure during service.

### BRIEF DESCRIPTION OF THE DRAWINGS

These and other features of the present invention and the attendant advantages will be readily apparent to those having ordinary skill in the art, and the invention will be more easily understood from the following detailed description of the preferred embodiments taken in conjunction with the accompanying drawings, wherein like reference characters represent like parts throughout the several views.

FIGS. 1A-E are substantially schematic sectional representations of several push-on joint designs for steel pipe as have been developed in the prior art.

FIG. 2 is a substantially schematic sectional illustration of a bell end of a length of steel pipe in accordance with a preferred embodiment of the present invention, with a spigot end of an adjoining pipe inserted therein to illustrate the relationship between the two portions in an assembled pipe joint.

FIG. 3 is a substantially schematic sectional illustration of a bell end of a length of steel pipe in accordance with a preferred embodiment of the present invention also showing a gasket being retained therein by the gasket retaining ring.

FIG. 4 is a substantially schematic sectional view of a bell end of a length of steel pipe in accordance with a preferred embodiment of the present invention, showing a continuous retaining ring secured therein.

FIG. 5 is a substantially schematic sectional view of a bell end of a length of steel pipe in accordance with a preferred embodiment of the present invention, showing a non-continuous retaining ring secured therein.

FIG. 6 is a substantially schematic sectional view of a bell end of a length of steel pipe in accordance with an alternative preferred embodiment of the present invention, with a spigot end of an adjoining pipe inserted therein to illustrate the relationship between the two portions in an assembled pipe joint.

FIG. 7 is a cross-sectional view illustrating the cross-sectional shape of a ring gasket designed for use with the FIG. 6 pipe joint.

### DETAILED DESCRIPTION OF THE PREFERRED EMBODIMENTS

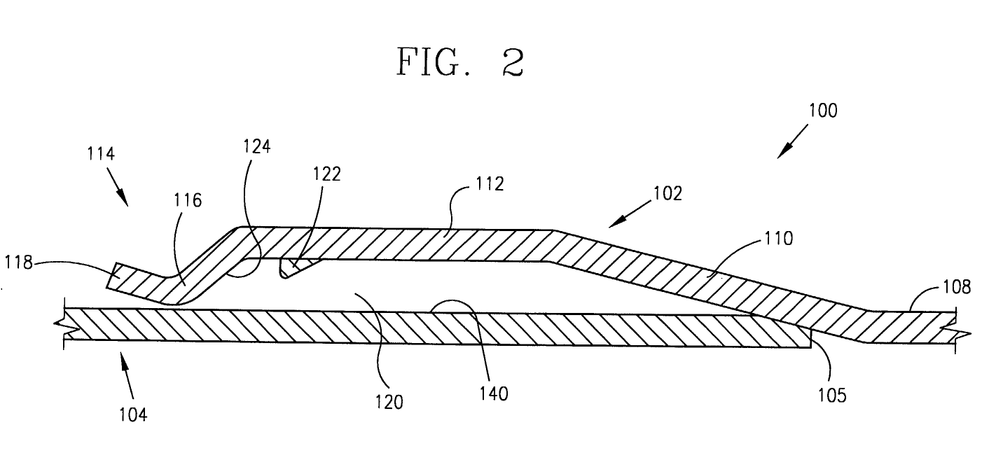

A bell end 102 and spigot end 104 of a push-on steel pipe joint 100 according to a preferred embodiment of the present invention, is shown in FIG. 2. A common type of steel pipe employed is known as “spiral welded” or “spiral weld” pipe, although the welded seam is not depicted in the drawing figures.

Each pipe section to be employed in constructing the pipeline will generally have a spigot end 104 at one end, and a bell end 102 at the other end, as is well known in the push-on pipe joint art. A pipeline is constructed by joining adjacent bell and spigot ends of the pipes to form a pipeline of a desired length. Other pipe section configurations are made, on occasion, for specific purposes. Short pipe sections having a bell end at each end may be produced for the purpose of joining two spigot-ended pipe members in certain piping layouts, for example

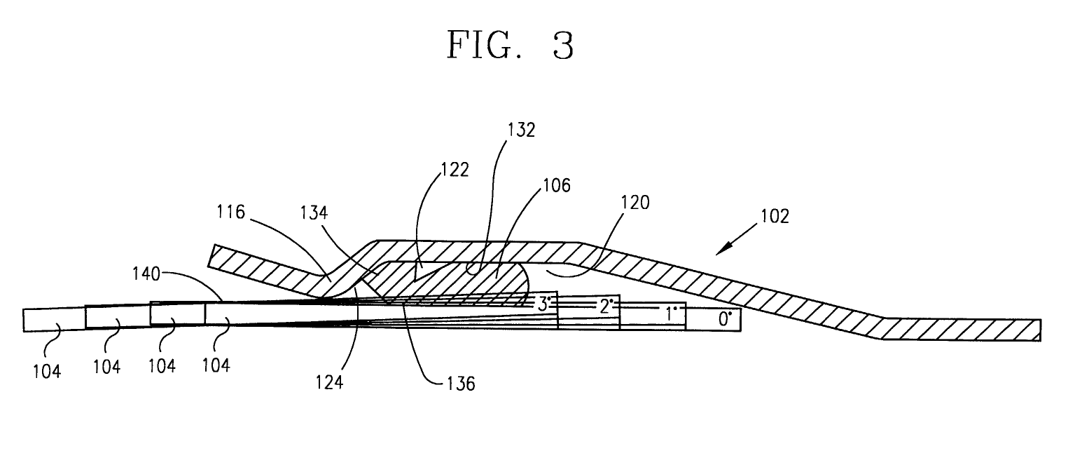

As can be seen in FIG. 2, the spigot end of the pipe is substantially cylindrical and of constant wall thickness, and is simply the terminal end of the length of pipe. A shallow chamfer or taper may be provided at the tip of the spigot end 105, which aids in insertion of the spigot end axially past the entry to the bell end and axially past the gasket 106 (FIG. 3). The chamfer also allows for slightly increased joint deflection as compared with a pipe end having a constant wall thickness all the way to the tip.

The bell end 102 of the pipe 100 is formed to have a greater diameter than the main length and spigot end of the pipe, such that it can accommodate and retain a spigot end therein. In a preferred embodiment of the bell end, the bell is formed such that the diameter is gradually increased from the main length of pipe 108 by an outward taper of the pipe wall. Once the tapered wall portion 110 reaches the desired bell diameter, the bell extends toward the open end in a substantially cylindrical or constant diameter portion 112.

A terminal portion 114 of the bell end is a necked-down wall portion extending forward of the constant diameter portion. The necked-down portion 116 preferably defines an opening that is slightly larger than the outer diameter of the spigot end of the pipe. The terminal portion 114 further has a radially outwardly flared portion 118 at the extreme end of the bell end of the pipe. This flared portion facilitates proper alignment of the spigot end with respect to the bell end as the spigot is inserted during joint makeup or assembly, in that the inner surface converges toward the narrower opening in the necked-down portion, and will thus serve to guide the tip of the spigot end toward the opening during the insertion operation.

The inner wall surfaces of the terminal portion 114, constant diameter portion 112, and the tapered wall portion combined to form a recessed area 120 within the bell end of the pipe. Within this recessed area, a gasket-retaining ring 122 is secured to the wall, preferably on the inner wall surface of the constant diameter portion 112. The retaining ring is preferably secured by either welding or gluing the ring to the inner wall surface, or is secured by some other substantially permanent attachment means.

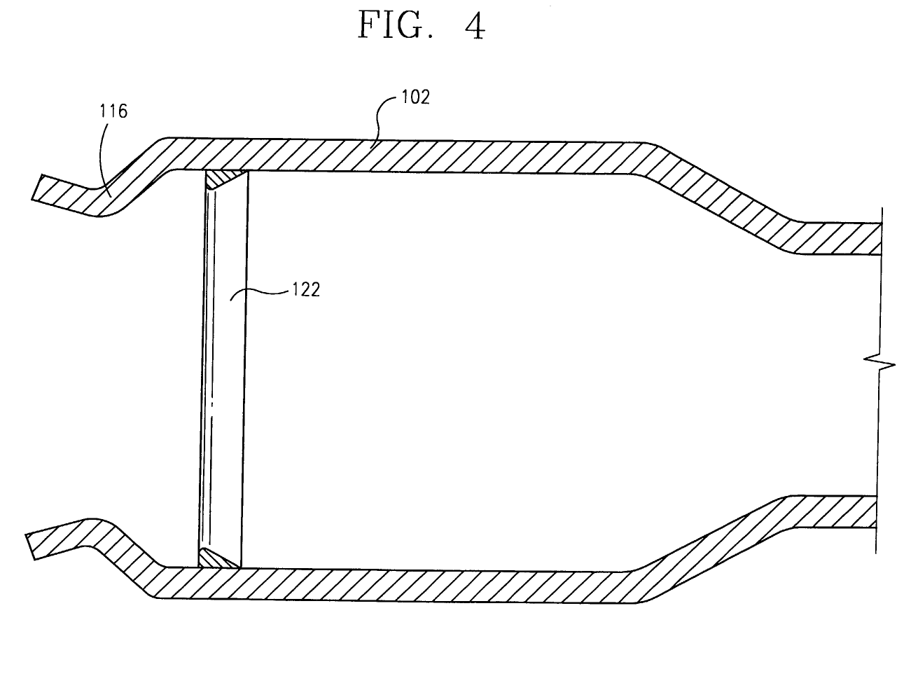

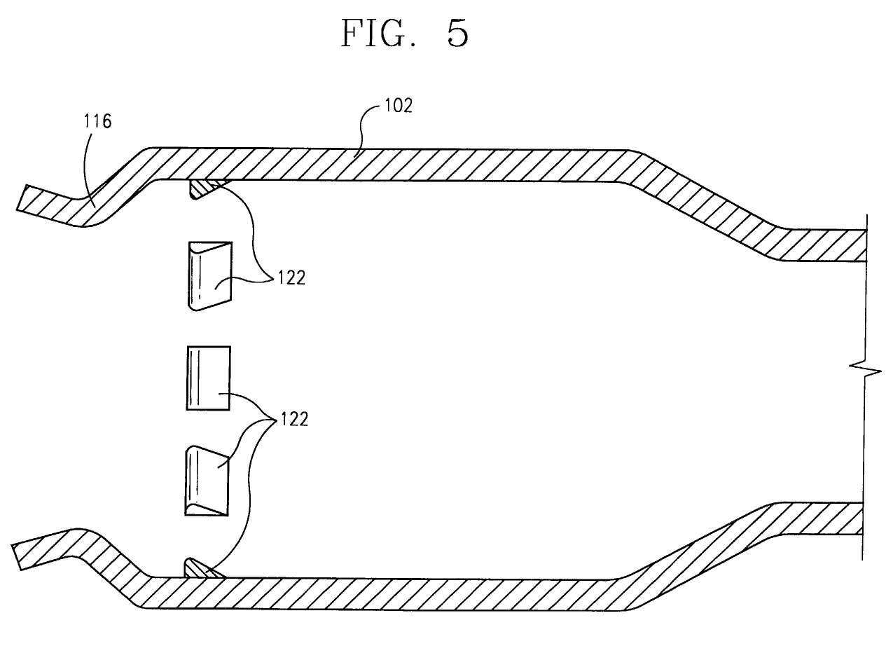

The retaining ring 122 may be either a contiguous ring spanning the entire inner circumference of the bell end (FIG. 4), or may be made up of a plurality of ring segments which are spaced apart from one another around the inner circumference of the bell end in a substantially ring-like manner (FIG. 5). Welding and gluing of the ring segments are appropriate ways to secure the segments to the inner wall of the bell end.

The retaining ring may preferably be of a wedge-like cross-sectional shape, as can be seen in FIG. 2. Although this is the preferred cross-sectional shape, that shape is not critical to the operation of the invention, and it would be possible to employ other shapes. Any shape which is capable of gripping into the outer surface of an elastomeric gasket that is to be employed, would be suitable for use in this invention.

The retaining ring 122 is spaced apart from the necked-down portion 116 of the bell. The inner wall surface 124 of the necked-down portion effectively forms a forward shoulder against which a forward portion of a gasket can seat. Turning to FIG. 3, it can be seen that gasket 106 is disposed in the recessed area, being engaged at an outer surface 132 thereof by the inner wall of the bell end and by retaining ring 122. In the illustrated preferred embodiment, the gasket 106 is elongated in the axial direction of the pipe sections with which it is used, and is engaged by the retaining ring 122 at a location intermediate the two ends of the gasket. A forward end 134 of gasket 106 abuts and is compressed by the inner wall surface 124 of the necked-down portion.

The outer diameter of the gasket is preferably slightly larger than the diameter of the recessed area 120, such that, when the gasket is installed in the recessed area, the gasket will be held in compression. The thickness of the gasket is selected such that it will present an opening that is smaller than the outer diameter of a spigot end portion of the pipe to be joined. In a known manner, the annular-shaped gasket is installed by folding or otherwise deforming the gasket such that it fits through the opening in the bell end. Once the gasket is moved within the bell to the area at which the retaining ring is located, the gasket is allowed to return to its annular shape to engage the retaining ring 122 and inner wall of the pipe. A visual inspection may be made to confirm that the gasket has been installed at its proper location.

Once the gasket 106 has been installed, the bell end 102 is ready to receive a spigot end 104 of a second section of pipe. As with other push-on style joints, the spigot end is simply advanced into the bell end in what will be referred to as an axial direction. Upon moving axially past the necked-down portion 116, the outer surface 140 of the spigot end engages the inner annular surface 136 of the gasket 106, which, as noted previously, presents an opening of a smaller diameter than the outer diameter of the spigot end of the pipe being inserted.

The spigot end 104 is further advanced axially, thereby compressing gasket 106, as the end of the spigot moves completely past the gasket 106 and to a desired position within the bell end. The physical interference of the gasket 106 with the spigot end 104 in prior art steel pipe joint designs would commonly cause the interposed gasket (carried on the spigot end) to roll, to be pushed, or to otherwise become displaced from its desired position. However, in the joint design of the present invention, the retaining ring 122 prevents the displacement of the gasket during the insertion process.

In addition, the retaining ring 122, and, to a degree, the inner wall surface 124 of the necked-down portion, also operates to hold the gasket in its proper position when joint separation forces are experienced, and when fluid pressure from inside the pipe during service is experienced.

The use of the retaining ring permits the use of considerably thicker gaskets of various cross-sectional shapes, when compared with the simple o-ring gaskets used in prior art steel pipe joint designs. The thicker gasket produces a more robust joint that will retain the fluid seal under increased offset loads and higher angles of joint deflection, as is seen with the four different joint deflection positions in FIG. 3. This is due to the ability to achieve a higher level of compression in the gasket, without the normally attendant risk of pushing the gasket out of place, as it is securely retained by the retaining ring 122.

FIG. 6 illustrates an alternative preferred embodiment of the bell end of a pipe section in accordance with the present invention. In this embodiment, pipe joint 200 is made up of a bell end 202 of one pipe section and a spigot end 204 of an adjoining pipe section.

The bell end 202 of the pipe in this embodiment differs in construction from the bell end 102 illustrated in the prior figures. In this embodiment, the terminal portion 214 of the bell end is not a necked-down portion. Instead, the bell is formed by having a radially outward tapered portion 210 extending axially away from the main length of pipe 208. Once the tapered wall portion 210 reaches the desired bell diameter, the bell extends toward the open end in a substantially cylindrical or constant diameter portion 212.

Instead of providing a necked-down wall portion at the terminal portion 214, the forward portion of the inner recessed area 220 is formed and defined by a roll-formed ring 250 which is welded at the entry to bell end 202, to effectively form a passage at the end of the bell end of a smaller diameter than that of the inner recessed portion of the bell end. The ring 250 is illustrated in FIG. 6 as being of a circular cross-section, however, it is envisioned that other cross-section shapes can be used for this ring. The important aspect is that the ring be substantially permanently secured in position, and that it be sized so as to prevent the gasket 206 from being pulled out of the bell end 202.

The use of the welded-in ring 250 presents a potentially more economical design in terms of production costs, than the other preferred embodiments. The bell end 202 is formed with this ring 250, and thereafter the gasket 206 is positioned therein preparatory to assembling the joint, in essentially the same manner as is done with the previously described embodiments.

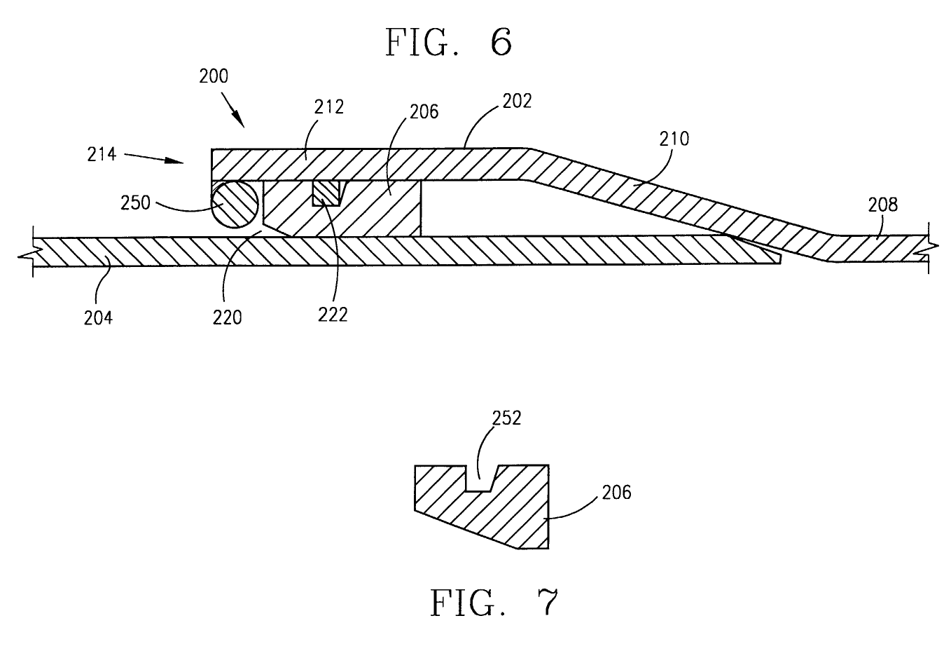

Turning to FIGS. 6 and 7 in combination, a preferred shape of gasket 206 for use with the pipe joint configuration of FIG. 6 is seen. The gasket-retaining ring 222 secured in the bell end 202 of the pipe (see FIG. 6) is shown to have a square or rectangular cross-sectional shape. Accordingly, gasket 206 is provided with a cutout area 252 on its outer wall which substantially corresponds to the shape of the retaining ring 222, with the back portion being angled slightly rearward, to provide a relief area when the gasket is compressed between the bell end 202 of one pipe section and the spigot end 204 of the adjoining pipe section.

As can be seen in FIG. 7, the gasket 206 is increasingly thicker in cross-section when in its uncompressed state. The thicker portion, which will be disposed axially inwardly of gasket retaining ring 222, will be pushed radially outwardly by the spigot end of the pipe section being inserted. This will cause the gasket to be compressed between the bell end and the spigot end, when the joint is assembled. This compression aids in firmly locking the gasket against the gasket-retaining ring, and provides the fluid tight seal for the joint.

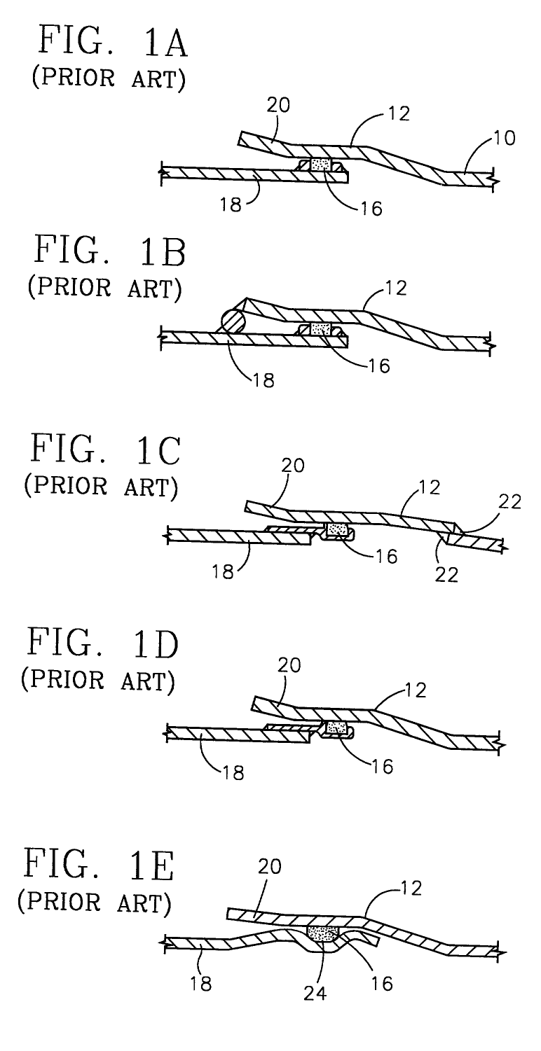

It is to be noted that the bell end joint configuration of FIG. 6 is distinguishable from joints in which a ring is welded to both the bell and the spigot in order to provide a restrained joint, such as is the case with the joint construction shown in FIG. 1b. In that construction, the ring is neither part of the bell end, nor of the spigot end, and is welded to both portions after the joint has been assembled, in order to “restrain” the joint such that the bell and spigot remain connected, albeit in a rigid manner. The ring cannot be welded to the bell end prior to insertion of the spigot end in that configuration, because the ring would prevent insertion of the spigot, which carries a gasket and two retaining rings thereon.

While the invention has been described in conjunction with specific embodiments thereof, it is recognized that modifications and variations will become apparent to those of ordinary skill in the art. Accordingly, the preferred embodiments of the invention as set forth herein are intended to be illustrative, and not limiting. Various changes may be made without departing from the true spirit and scope of the invention as defined in the appended claims.

What is claimed is:

1. A steel pipe element comprising a bell end and a main section terminating in a spigot end, said bell end having an opening of a predetermined size, and an annular recess in an interior thereof, a front axial portion of said annular recess being bounded by a tapered wall of said steel pipe element, such that said recess, in said front part, increases in diameter moving in an axially inward direction;
a gasket retaining ring secured to an inner wall surface of said steel pipe element said gasket retaining ring extending circumferentially around an interior of said steel pipe element in said annular recess portion thereof, and protruding radially inwardly into said annular recess portion.

2. A steel pipe element as recited in claim 1, wherein said gasket retaining ring comprises a contiguous ring extending circumferentially around an entire circumference of said recess portion.

3. A steel pipe element as recited in claim 1, wherein said gasket retaining ring comprises a plurality of ring segments spaced apart from one another around the inner circumference of the annular recess portion in a substantially ring-like manner.

4. A steel pipe element as recited in claim 2, wherein said gasket retaining ring is substantially wedge-shaped in cross-section.

5. A steel pipe element as recited in claim 3, wherein said gasket retaining ring is substantially wedge-shaped in cross-section.

6. A pipe joint comprising:
a first steel pipe element having a bell end, said bell end having an opening of a predetermined size, and an annular recess in an interior thereof, a front axial portion of said annular recess being bounded by a tapered wall of said first steel pipe element, such that said recess, in said front part, increases in diameter moving in an axially inward direction;
a gasket retaining ring secured to an inner wall surface of said first steel pipe element, said gasket retaining ring extending circumferentially around an interior of said first steel pipe element in said first annular recess portion thereof, and protruding radially inwardly into said annular recess portion;
a second steel pipe element having a spigot end adapted to be inserted into, and retained in, said bell end of said first steel pipe element;
an annular gasket made of resilient material and sized to have an outer diameter which is larger than an inner diameter of said annular recess, at the position where the gasket retaining ring is secured, such that the gasket is retained within said annular recess in compression;
said annular gasket being positioned in said bell end of said first steel pipe element to be engaged and retained by said gasket retaining ring.

7. A pipe joint as recited in claim 6 wherein said gasket-retaining ring comprises a contiguous ring extending circumferentially around an entire circumference of said recess portion.

8. A pipe joint as recited in claim 6 wherein said gasket-retaining ring comprises a plurality of ring segments spaced apart from one another around the inner circumference of the annular recess portion in a substantially ring-like manner.

9. A pipe joint as recited in claim 7, wherein said gasket retaining ring is substantially wedge-shaped in cross-section.

10. A pipe joint as recited in claim 8, wherein said gasket retaining ring is substantially wedge-shaped in cross-section.

11. A method of producing a steel pipe element comprising:
plastically deforming a steel plate into a substantially cylindrically shaped portion over a majority of a length of said steel pipe element;
at one end of said steel pipe element, forming said steel plate into a bell end section having a larger diameter than said cylindrically shaped portion, wherein said bell end has an outwardly tapered portion extending from said cylindrically shaped portion, a substantially constant diameter portion extending from said outwardly tapered portion, and a necked-down portion at a terminal end of said bell end section;
welding said steel plate along adjacent edges of said steel plate; and
securing, to an inner surface of said substantially constant diameter portion, a gasket retaining ring extending circumferentially around said inner surface.

12. A method as recited in claim 11, wherein said step of securing said gasket retaining ring comprises securing a substantially contiguous ring member to said inner surface of said constant diameter portion.

13. A method as recited in claim 12, wherein said step of securing said gasket retaining ring comprises securing a plurality of ring segments at circumferentially spaced apart locations around the inner circumference of said constant diameter portion.

14. A method as recited in claim 12, wherein said gasket retaining ring is made of steel, and said securing is effected by welding.

15. A method as recited in claim 13, wherein said gasket retaining ring is made of steel, and said securing is effected by welding.
